(19) United States
(12) Patent Application Publication
(10) Pub. No.: US 2013/0133910 A1
(43) Pub. Date: May 30, 2013

(54) ELECTRIC DRIVE FOR A HAND-HELD POWER TOOL

(71) Applicant: Hilti Aktiengesellschaft, Schaan (LI)

(72) Inventors: Reinhard RIEDL, Finning (DE); Helmut BURGER, Prittriching (DE); Dietmar BURGER, Jengen (DE); Michael MORGENSTERN, Landsberg (DE)

(73) Assignee: Hilti Aktiengesellschaft, Schaan (LI)

(21) Appl. No.: 13/683,653

(22) Filed: Nov. 21, 2012

(30) Foreign Application Priority Data
Nov. 25, 2011 (DE) DE102011087117.9

(51) Int. Cl. B25D 16/00; H02K 11/00

(52) U.S. Cl. CPC B25D 16/00; H02K 11/0005
USPC 173/109; 310/72

(57) ABSTRACT

An electric drive for a hand-held power tool. An electric supply line contains two or more stranded wires. An electric motor is electrically connected to the stranded wires. The stranded wires pass at least twice through the eye of a toroidal core. A partition divides the eye into several sectors. Precisely one of the stranded wires passes through each of the sectors. The stranded wires are arranged along the circumference of the eye so as to follow each other cyclically.

This claims the benefit of German Patent Application DE 10 2011 087 117.9, filed Nov. 25, 2011 and hereby incorporated by reference herein.

The present invention relates to an electric drive for a hand-held power tool. Portable hand-held power tools are subject to statutory regulations in terms of the interfering electromagnetic radiation that they emit. The electric motor of a hand-held power tool is a source of such interfering radiation, especially while it is being switched on and off or in the case of speed-controlled electric motors, also during operation.

### SUMMARY OF THE INVENTION

It is an object of the present invention to provide an electric drive for a hand-held power tool that has less interfering radiation, without there being a need to restrict the power output of the electric motor. An electric supply line contains two or more stranded wires. The electrically conductive stranded wires are electrically insulated vis-à-vis each other so that they can have differing electric potentials. An electric motor is electrically connected to the stranded wires. The stranded wires supply current to the magnet coils or windings, especially the stator windings of the electric motor. The stranded wires pass at least twice through the eye of a hollow-cylindrical toroidal core. A partition divides the eye into several sectors. Precisely one of the stranded wires passes through each of the sectors. The stranded wires are arranged along the circumference of the eye so as to follow each other cyclically.

The partition reduces the space available within the eye. Consequently, the number of windings around the toroidal core is markedly restricted. Nevertheless, such a compelled regular arrangement proves to be more suitable in order to achieve a damping of the high-frequency interfering radiation. This applies especially to the stranded wires of the electric motor that carry high currents. Their required cross section results in considerable stiffness, which makes spatially ordered mechanical winding more difficult.

The toroidal core is, for example, a ferrite core that preferably consists completely of ferrite, for example, hematite or magnetite. As an alternative, the toroidal core can be made by compressing iron powder and been mixed with cobalt and/or nickel.

One embodiment provides a motor control unit that cyclically changes the current flow in the stranded wires by a fixed phase shift. The motor control unit can contain several connecting bridges that actuate the magnet coils or windings individually.

One embodiment provides that the electric supply line contains precisely three stranded wires and the stranded wires preferably pass through the eye precisely twice. In the case of six sectors and passages through the eye, the damping property achieved by the partition has proven to be especially advantageous vis-à-vis the space loss and a free multiple winding.

One embodiment provides that precisely one of the stranded wires passes through each of the sectors and that the sectors are preferably exactly the same size. This is especially advantageous in the case of three stranded wires. In this manner, each stranded wire is adjacent to the two other stranded wires in the circumferential direction and they are at the same distance. The phase-shifted currents in the case of the three-core supply lines can optimally compensate for each other in the eye. The number of sectors is preferably an integer multiple, at least two times the number of stranded wires.

One embodiment provides that the partition has a number of ribs that is equal to the number of sectors and that touch an inner wall of the toroidal core. An interior conductor of the partition preferably occupies the axis or center of the toroidal core so as not to permit any stranded wire to be located in the center.

One embodiment provides that a cross sectional surface of one of the sectors is less than two times the size of a cross sectional surface of one of the stranded wires.

A hand-held power tool preferably has a grip and one of the electric drives described above. A striking mechanism and/or a rotating tool socket are driven by the electric drive.

### BRIEF DESCRIPTION OF THE DRAWINGS

The description below explains the invention on the basis of figures and embodiments by way of example. The figures show the following:

FIG. 1 a hammer drill,

FIG. 2 a circuit diagram of the electric drive,

FIG. 3 an electric drive of the hammer drill,

FIG. 4 a bottom view of an interfering-radiation damper,

FIG. 5 a longitudinal section through the interfering-radiation damper in the plane V-V of FIG. 4,

FIG. 6 a top view of the partition,

FIG. 7 a longitudinal section in the plane VII-VII of FIG. 6.

### DETAILED DESCRIPTION

Unless otherwise indicated, identical or functionally equivalent elements are designated by the same reference numerals in the figures.

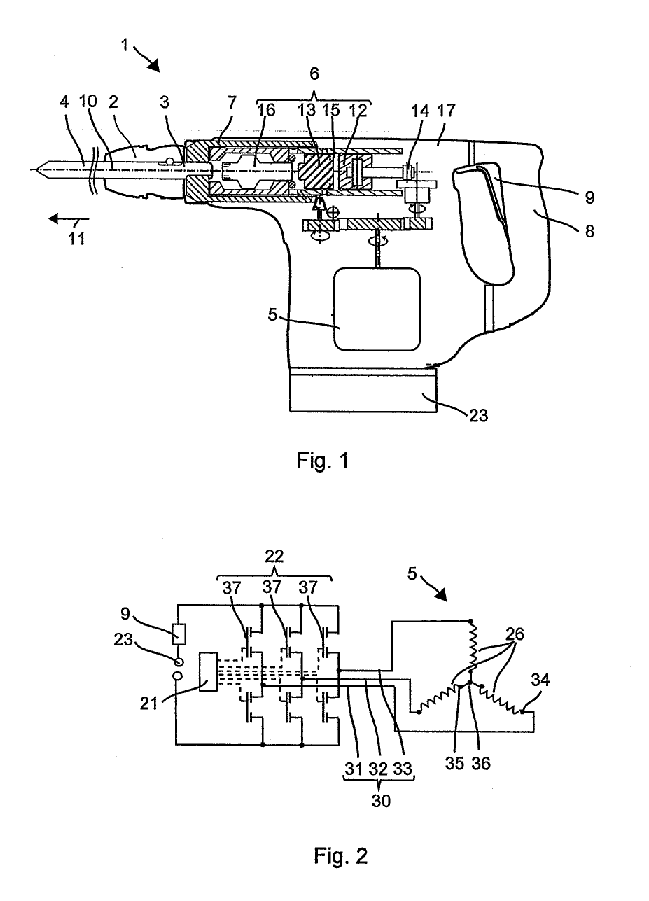

FIG. 1 schematically shows a hammer drill 1 as an example of a hand-held power tool. The hammer drill 1 has a tool socket 2 into which a shank end 3 of a tool, e.g. a drill chisel 4, can be inserted. An electric motor 5 that drives a striking mechanism 6 and a driven shaft 7 constitutes the primary drive of the hammer drill 1. A user can handle the hammer drill 1 by means of a grip 8 and can start up the hammer drill 1 by means of a system switch 9. During operation, the hammer drill 1 continuously rotates the drill chisel 4 around a working axis 10, and in this process, it can hammer the drill chisel 4 into a substrate in the striking direction 11 along the working axis 10.

The striking mechanism 6 is, for example, a pneumatic striking mechanism 6. An exciter 12 and a striker 13 are installed in the striking mechanism 6 so as to be movable along the working axis 10. The exciter 12 is coupled to the motor 5 via an eccentric 14 or a toggle element, and it is forced to execute a periodic, linear movement. An air spring formed by a pneumatic chamber 15 between the exciter 12 and the striker 13 couples a movement of the striker 13 to the movement of the exciter 12. The striker 13 can strike a rear end of the drill chisel 4 directly or it can transmit part of its pulse to the drill chisel 4 indirectly via an essentially stationary intermediate striker 16. The striking mechanism 6 and preferably the other drive components are arranged inside a machine housing 17.

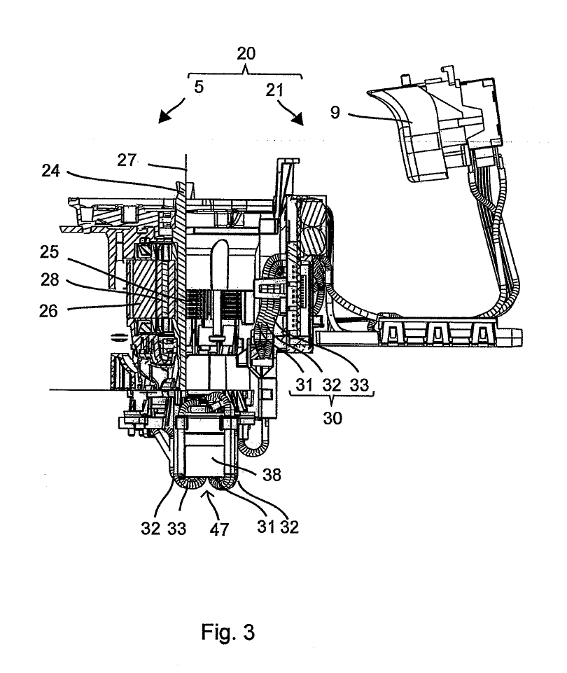

FIG. 2 shows a circuit diagram of the electric drive 20, and FIG. 3 shows a side view of the electric drive 20. The electric motor 5 is, for instance, a brushless electric motor that is actuated by a motor control unit 21 with a switched bridge circuit 22. The system switch 9 activates the bridge circuit 22 and/or connects the bridge circuit to the power supply 23. Power is supplied to the electric motor 5, for example, by means of a battery pack 23 that is detachably affixed to the machine housing 17. As an alternative, the power supply can be obtained from the mains network.

The electric motor 5 is, for example, a brushless direct current motor (BLDC motor) 5. The electric motor 5 has a rotor 24 and a coaxial stator 25 that surrounds the rotor 24 in the direction of rotation. The stator 25 has several magnet coils 26 that are arranged around the motor axis 27 so as to be offset in the direction of rotation. The motor control unit 21 cyclically changes the current flow through the magnet coils 26 in order to generate a magnetic field that migrates in or opposite to the direction of rotation. Permanent magnets 28 are attached to the rotor 24 as a function of the number of pole pairs, said magnets being oriented in accordance with the magnetic field and consequently rotating along with the rotor 24, as the magnetic field migrates.

The electric motor 5 given by way of an example has three magnet coils 26 connected in a star-shaped pattern. An electric supply line 30 connects the magnet coils 26 to the motor control unit 21 by means of a first stranded wire 31, a second stranded wire 32, and a third stranded wire 33. A first terminal 34 of each of the magnet coils 26 is connected to one of the stranded wires 31, 32, 33. Second terminals 35 of the magnet coils 26 are combined to form a shared star point 36. The bridge circuit 22 contains a bridge 37 for each stranded wire 31, 32, 33, that is to say, for each magnet coil 26. A switching cycle given by way of an example has three discrete phases. In a first phase, a current flows from the power supply 23 via the first stranded wire 31 through two of the magnet coils 26 into the second stranded wire 32. The third stranded wire 33 is currentless. In the second phase, a current flows from the second stranded wire 32 via two magnet coils 26 into the third stranded wire 33, and the first stranded wire 31 is currentless. In the third phase, a current flows from the third stranded wire 33 via two of the magnet coils 26 into the first stranded wire 31, and the second stranded wire 32 is currentless.

The electric motor 5 is described by way of an example. In particular, the electric motor can have more than three magnet coils 26, which are connected in a star-shaped pattern. Each stranded wire can be associated with exactly one magnet coil 26, as described above. In other embodiments, several magnet coils 26 that are combined into a group can be connected to the power supply 23 via a shared stranded wire 31, 32, 33. For example, in the case of six magnet coils 26, each of the diametrically opposed magnet coils 26 can be connected to the same stranded wire. Moreover, the magnet coils 26 can be joined to form a closed ring, for example, a triangle. Each terminal of the magnet coils 26 is connected to a stranded wire 31, 32, 33, whereby the adjacent magnet coils 26 share a stranded wire 31, 32, 33. The electric motor 5 can also be a reluctance motor or an asynchronous motor.

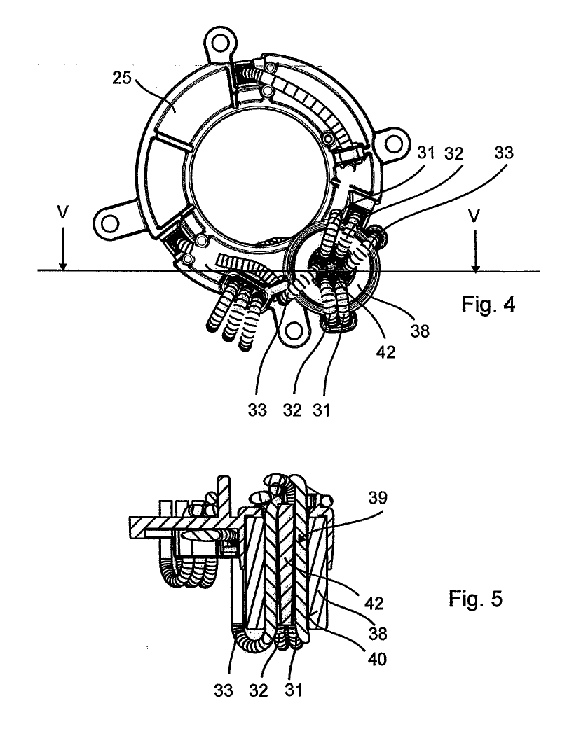

The feed line 30 is wound, for example, twice around the toroidal core 38 (see FIGS. 4 and 5). The stranded wires 31, 32, 33 pass twice through the eye 39 of the toroidal core 38. The toroidal core 38 preferably has the shape of a hollow circular cylinder. The inner wall 40 of the cylinder that delimits the eye 39 is parallel to the axis 41 of the cylinder. The stranded wires 31, 32, 33 lie flat against the inner wall 40 and are oriented essentially in parallel to the axis 41.

The toroidal core 38 consists predominantly of a soft-magnetic, ferromagnetic material, for example, of at least one material from the group of hematite or magnetite. Additives can be nickel, zinc or manganese compounds. Furthermore, the toroidal core can be made by compressing iron powder and it can contain additives of cobalt and/or nickel. Alternative embodiments provide for a wound toroidal core 38. The toroidal core can also be made of a band containing iron and nickel and wound to form a toroid.

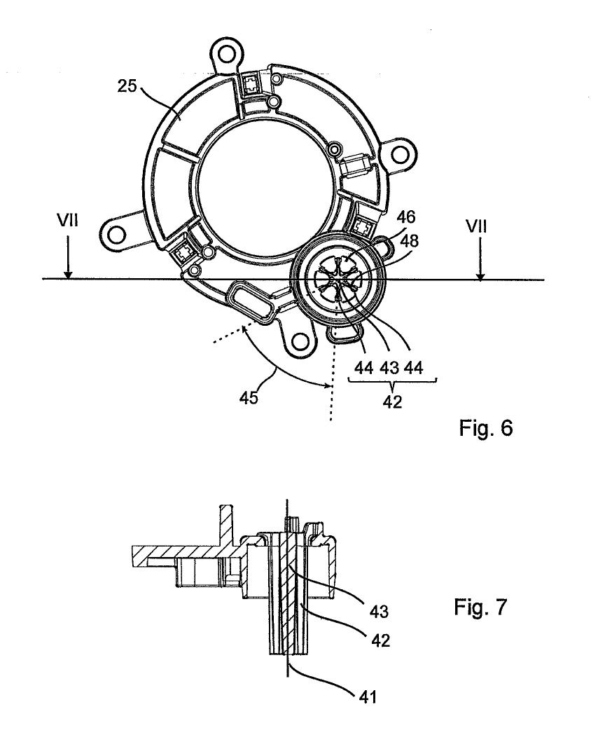

A partition 42 is arranged in the toroidal core 38. The partition 42 has a star-shaped cross sectional profile relative to the axis 41. FIGS. 6 and 7 show the partition without the toroidal core 38 and the stranded wires. The partition 42 has an interior conductor 43 that runs coaxially to the axis 41. The partition 42 fills up part of the eye 39 and preferably occupies the axis 41 over the entire length of the toroidal core. Ribs 44 project from the interior conductor 43 in the radial direction, and these ribs 44 are arranged at largely equidistant angle intervals. In the preferred example, six ribs 44 are provided that are arranged consecutively so as to be offset by 60°. As shown, the ribs 44 can touch the inner wall 40 of the toroidal core 38. The ribs 44 divide the eye 39 into several sectors 45, as shown here, for example, into six sectors 45. A channel 46 runs in the sector 45 parallel to the axis 41. The channel 46 is defined by two ribs 44 and by the toroidal core 38, that is to say, these ribs 44 and the toroidal core 38 form an inner wall of the channel 46 in the plane perpendicular to the axis 41.

Each of the sectors 45 or the channel 46 accommodate exactly one stranded wire 31, 32, 33. The stranded wires 31, 32, 33 are arranged around the axis 41 in the circumferential direction in a cyclically repeating sequence. In the preferred example the first stranded wire 31, the second stranded wire 32, and the third stranded wire 33 are arranged in sequence in immediately adjacent sectors 45. The sequence is repeated exactly twice along the circumference of the toroidal core 38.

In the embodiment shown, the stranded wires 31, 32, 33 run inside the eye 39 so as to be oriented in the same direction. The first stranded wire 31—in a running direction starting from the motor control unit 21—enters the eye 39 at the bottom 47 of the toroidal core 38. The second time, the first stranded wire 31 once again enters the toroidal core 38 at the bottom 47. The other stranded wires 31, 33 likewise enter at the bottom 47 each time, in the same running direction as the first stranded wire 31. The stranded wires 31, 32, 33 are returned once to the bottom 47 outside of the eye 39.

The cross sectional surface of the channels 46 is preferably about the same size or up to twice as large as the cross sectional surface of the stranded wires 31, 32, 33. The strict layout of the stranded wires 31, 32, 33 ensures a uniform orientation of the stranded wires 31, 32, 33, as a result of which a good damping behavior of the toroidal core 38 when it comes to high-frequency switching signals can be achieved. In the embodiment given by way of an example, the channels 46 have a partially circular cross section. The circular section 48 encloses more than 180° in order to surround the stranded wire 31, 32, 33 in question.

The partition 42 is made of a non-magnetizable material. For example, the partition 42 is made of plastic.

The motor 5 shown here is suitable not only for a hammer drill, but also for an electric screwdriver, a demolition hammer, a saw, a circular saw, a reciprocating saw, an impact screwdriver or other electrically driven power tools, especially hand-held power tools.

1. An electric drive for a hand-held power tool comprising:
an electric supply line containing two or more stranded wires;
an electric motor electrically connected to the stranded wires;
a hollow-cylindrical toroidal core having an eye, the stranded wires passing at least twice through the eye, and having a partition dividing the eye into several sectors, one of the stranded wires passing through each of the sectors, the stranded wires being arranged along the circumference of the eye.

2. The electric drive as recited in claim 1 further comprising a motor control unit cyclically changing a current flow in the stranded wires by a fixed phase shift.

3. The electric drive as recited in claim 2 wherein the electric supply line contains precisely three or more than three stranded wires.

4. The electric drive as recited in claim 1 wherein the sectors are of a same size.

5. The electric drive as recited in claim 1 wherein precisely one of the stranded wires passes through each of the sectors.

6. The electric drive as recited in claim 5 wherein the number of sectors is an integer multiple, at least two times a number of the stranded wires.

7. The electric drive as recited in claim 1 wherein the partition has a number of ribs equal to the number of sectors, the ribs pointing to an inner wall of the toroidal core.

8. The electric drive as recited in claim 7 wherein a channel surrounds one of the stranded wires over at least half of a circumference in a form-fitting manner.

9. The electric drive as recited in claim 1 wherein the toroidal core is made of ferrite or iron powder containing additives of cobalt or nickel.

10. A hand-held power tool with a grip comprising:
the electric drive as recited in claim 1; and
at least one of a striking mechanism and a rotating tool socket driven by the electric drive.
